(19) United States
(12) Patent Application Publication
(10) Pub. No.: US 2014/0086657 A1
(43) Pub. Date: Mar. 27, 2014

(54) IMAGE FORMING APPARATUS

(71) Applicant: Konica Minolta, Inc., Tokyo (JP)

(72) Inventors: Ken NONAKA, Tokyo (JP); Takahiro OKUBO, Tokyo (JP); Yoshiteru KAWAKAMI, Tokyo (JP)

(73) Assignee: Konica Minolta, Inc., Tokyo (JP)

(21) Appl. No.: 13/974,466

(22) Filed: Aug. 23, 2013

(30) Foreign Application Priority Data
Sep. 25, 2012 (JP) 2012-210351

(51) Int. Cl. G03G 15/00

(52) U.S. Cl. CPC G03G 15/1615
USPC 399/388

(57) ABSTRACT

An image forming apparatus includes an image carrier onto which toner images formed by an image forming part are sequentially transferred so as to overlap one another and form a toner image thereupon, a transfer part transferring the toner image onto a transfer material conveyed thereto, a conveyance part conveying the transfer material toward the transfer part, the conveyance part having a roller to which the rotational driving force is transmitted by a spur gear, and a transfer material main-scanning direction position correction mechanism for correcting deviation in a transfer material position in a main-scanning direction, and a control part to perform correction of a transfer material position in the main-scanning direction and that in the sub-scanning direction by changing rotational velocity of the roller, in a time overlapping manner.

### CROSS REFERENCES TO RELATED APPLICATIONS

The present invention contains subject matter related to Japanese Patent Application JP 2012-210351 filed in the Japanese Patent Office on Sep. 25, 2012, the entire contents of which being incorporated herein by reference.

### BACKGROUND OF THE INVENTION

1. Field of the Invention

The present invention relates to an image forming apparatus that transfers a toner image formed on an image carrier, such as a photoreceptor, to a transfer material, such as a sheet, and more particularly, relates to an image forming apparatus that corrects the position of the transfer material in a sub-scanning direction by changing the rotational velocity of a roller, such as a registration roller, to which a rotational driving force is transmitted by a spur gear.

2. Description of the Related Art

An image forming apparatus, such as a copying machine, a printer, a facsimile machine, and a multi-function machine, has spread, which forms an image on a transfer material, such as a sheet, by forming an electrostatic latent image on a photoreceptor by exposing the charged photoreceptor based on image data, forming a toner image on the photoreceptor by causing toner to adhere onto the latent image on the photoreceptor, and transferring the toner image on the photoreceptor onto the transfer material.

In such an image forming apparatus, in general, in a conveyance part configured to convey the transfer material conveyed thereto to a transfer position where the toner image on the photoreceptor is transferred onto the transfer material, a registration roller is arranged on the immediate upstream side of the transfer position. After the transfer material has been conveyed to the registration roller, the conveyance part sends out the transfer material to the transfer position by the registration roller at the timing that the toner image on the photoreceptor is transferred onto the transfer material.

As a method for correcting a deviation in position of a transfer material in a main-scanning direction (direction perpendicular to the conveyance direction of the transfer material) that has occurred during conveyance of the transfer material to the registration roller, a method is used in which a mechanism for moving the registration roller in the main-scanning direction is provided. The registration roller is moved in the main-scanning direction in the state that the transfer material has been nipped by the registration roller, and thereby the deviation in position of the transfer material in the main-scanning direction when the transfer material is sent out by the registration roller toward the transfer position is corrected.

Further, as a method for correcting variations in the timing that the transfer material is actually sent out by the registration roller, after the rotation of the registration roller has started to send out the transfer material to the transfer position, that is, as a method for correcting a deviation in position of the transfer material in the sub-scanning direction (the conveyance direction of the transfer material) when the toner image on the photoreceptor is transferred at the transfer position onto the transfer material sent out by the registration roller and conveyed to the transfer position, a method is used in which the rotational velocity of the registration roller is changed.

In a conventional image forming apparatus, correction of the transfer material position in the main-scanning direction by moving the registration roller in the main-scanning direction as described above and correction of the transfer material position in the sub-scanning direction by changing the rotational velocity of the registration roller as described above are performed at different times, for example, such that the correction of the transfer material position in the sub-scanning direction is started after the correction of the transfer material position in the main-scanning direction has been completed.

As the technique relating to the correction of the transfer material position in the main-scanning or sub-scanning direction, the following [1] to [3] are known.

[1] In an image forming apparatus in which a mechanism for moving a registration roller in the main-scanning direction is provided, by attaching a tip detection sensor to detect the tip of a transfer material in such a manner that the tip detection sensor moves integrally with the registration roller, the output of the tip detection sensor is made stable even if the registration roller is moved in the state that the transfer material has been nipped by the registration roller (for example, see Patent Literature 1).

[2] In an image forming apparatus in which a mechanism for moving a registration roller in the main-scanning direction is provided, if it is detected that the amount of movement of the registration roller in the main-scanning direction exceeds a predetermined amount, correction of the transfer material position is completed before the tip of the transfer material reaches another conveyance roller, by adjusting the conveyance speed and/or the moving speed of the registration roller (for example, see Patent Literature 2).

[3] A sensor to detect the tip and the side end of a transfer material is provided between a registration roller and a transfer position, and the position of the transfer material is corrected based on the detection result of the sensor (for example, see Patent Literature 3).

However, in Patent Literature 1 described above, correction of the transfer material position in the sub-scanning direction is not mentioned at all, and in Patent Literatures 2 and 3 described above, the timing that correction of the transfer material position in the sub-scanning direction is started is not mentioned at all
Patent Literature Japanese Patent Application Laid-Open Publication No. 1994-40608
Patent Literature 2: Japanese Patent Application Laid-Open Publication No. 2000-280554
Patent Literature 3: Japanese Patent Application Laid-Open Publication No. 2006-301087

### SUMMARY OF THE INVENTION

When a mechanism for moving the registration roller in the main-scanning direction is provided, as a gear to transmit the rotational driving force from a motor to the registration roller, a spur gear capable of displacement in the thrust direction is used. The spur gear, however, in general, has a tooth contact ratio lower than that of a helical gear. Meanwhile, in a conventional image forming apparatus, correction of the transfer material position in the sub-scanning direction is started after correction of the transfer material position in the main-scanning direction has been completed. Therefore, because of the time constraint imposed on the time for the transfer material to reach the transfer position after having been started to be sent out by the registration roller toward the transfer position, the time for correcting the transfer material position in the sub-scanning direction by reducing the rotational velocity of the registration roller becomes relatively limited, and the amount of change in the rotational velocity of the registration roller per unit time when correcting the transfer material position in the sub-scanning direction becomes relatively large. If the amount of change in the rotational velocity of the registration roller per unit time becomes relatively large as described above, the load imposed on the gear to transmit the rotational driving force to the registration roller generally fluctuates, and in the case of the spur gear having the low tooth contact ratio, the rotation accuracy of the registration roller reduces.

In view of the above-mentioned point, the present invention has an object to prevent the rotation accuracy of a roller, to which the rotational driving force is transmitted by a spur gear, from reducing, in an image forming apparatus that corrects the transfer material position in the sub-scanning direction by changing the rotational velocity of the roller.

To achieve the above-mentioned object, an image forming apparatus reflecting one aspect of the present invention includes: an image carrier onto which toner images formed by an image forming part are sequentially transferred so as to overlap one another and form a toner image thereupon; a transfer part configured to transfer the toner image formed on the image carrier onto a transfer material conveyed thereto; a conveyance part configured to send out the transfer material, onto which the toner image on the image carrier is to be transferred at the transfer part, toward the transfer part, the conveyance part including a roller to which a rotational driving force is transmitted and which, by being rotated by the rotational driving force, sends out the transfer material toward the transfer part, and a transfer material main-scanning direction position correction mechanism configured to correct a position of the transfer material in a main-scanning direction when the transfer material is sent out by the roller from the conveyance part toward the transfer part; and a control part configured to perform the correction of the position of the transfer material in the main-scanning direction by the transfer material main-scanning direction position correction mechanism of the conveyance part, and correction of a position of the transfer material in a sub-scanning direction when the toner image on the image carrier is transferred at the transfer part onto the transfer material conveyed thereto by changing a rotational velocity of the roller of the conveyance part, in a time overlapping manner.

### BRIEF DESCRIPTION OF THE DRAWINGS

FIG. 1 is a diagram showing configurations of an image forming part, an intermediate transfer belt, a secondary transfer part, a fixing part, etc. of an image forming apparatus according to an embodiment of the present invention.

FIG. 2 is a diagram showing configurations of a registration roller and its peripheral portions in the image forming apparatus according to the embodiment of the present invention.

FIG. 3 is a block diagram showing a configuration of a control system of the image forming apparatus according to the embodiment of the present invention.

FIG. 4A and FIG. 4E are diagrams showing correction of a sheet position in a main-scanning direction in the image forming apparatus according to the embodiment of the present invention.

FIG. 5 is a diagram showing correction of a sheet position in a sub-scanning direction in the image forming apparatus according to the embodiment of the present invention.

FIG. 6 is a diagram showing a temporal relationship between the correction of the sheet position in the main-scanning direction and the correction of the sheet position in the sub-scanning direction in the image forming apparatus according to the embodiment of the present invention.

### DETAILED DESCRIPTION OF THE PREFERRED EMBODIMENT(S)

Hereinafter, an embodiment of the present invention is explained with reference to the drawings.

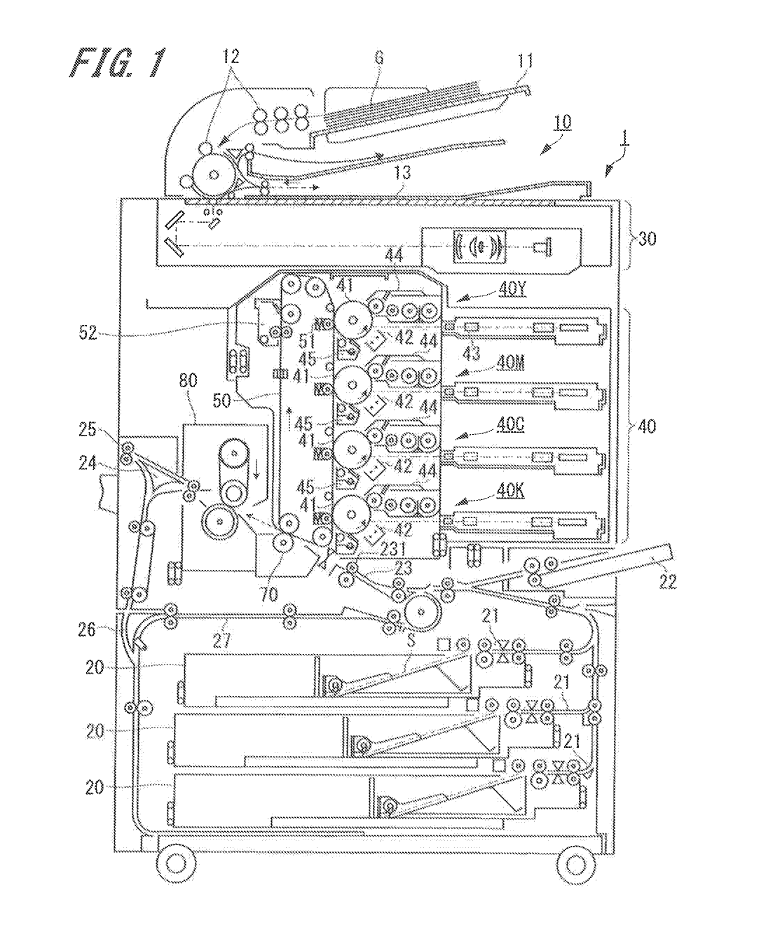

FIG. 1 shows configurations of an image forming part, an intermediate transfer belt, a secondary transfer part, a fixing part, etc. of an image forming apparatus according to the embodiment of the present invention. An image forming apparatus 1 forms an image on a sheet by electrophotography, and is a color image forming apparatus adopting a tandem method in which toners of four colors of yellow (Y), magenta (M), cyan (C), and black (Bk) are overlapped. The image forming apparatus 1 has an original conveyance part 10, sheet storage parts 20, an image reading part 30, an image forming part 40, an intermediate transfer belt 50, a secondary transfer part 70, and a fixing part 80.

The original conveyance part 10 has an original feed table 11 on which originals G are set, and a plurality of rollers 12. The originals G set on the original feed table 11 of the original conveyance part 10 are conveyed one by one to a read position of the image reading part 30 by the plurality of rollers 12. The image reading part 30 reads an image of each original G conveyed to the read position by the original conveyance part 10 or an image of an original G placed on a platen 13, and generates image data of the image of the original G.

The sheet storage parts 20 are arranged at the lower part of the apparatus main body and are provided for each size of sheets S. The sheets S in the sheet storage parts 20 are fed one by one by respective feed parts 21, and each sheet S is conveyed to a conveyance part 23, and then to the secondary transfer part 70, which is the transfer position, by the conveyance part 23. In the vicinity of the sheet storage parts 20, a manual feed part 22 is provided. From the manual feed part 22, a special sheet, such as, a sheet of a size not stored in the sheet storage parts 20, a tag sheet having a tag, an OHP sheet, etc. is sent to the transfer position.

Between the image reading part 30 and the sheet storage parts 20, the image forming part 40 and the intermediate transfer belt 50 are arranged. The image forming part 40 has four image forming units 40Y, 40M, 40C, and 40K for forming toner images of respective colors of yellow (Y), magenta (M), cyan (C), and black (Bk).

The first image forming unit 40Y forms a yellow toner image, and the second image forming unit 40M forms a magenta toner image. The third image forming unit 40C forms a cyan toner image, and the fourth image forming unit 40K forms a black toner image. The four image forming units 40Y, 40M, 40C, and 40K have the same configuration, and therefore, here, the first image forming unit 40Y is explained.

The first image forming unit 40Y has a drum-shaped photoreceptor 41, a charging part 42 arranged around the photoreceptor 41, an exposure part 43, a developing part 44, and a cleaning part 45. The photoreceptor 41 rotates in the counterclockwise direction by a drive motor, not shown schematically. The charging part 42 gives charges to the photoreceptor 41 to charge the surface of the photoreceptor 41 uniformly. The exposure part 43 performs exposure scanning on the surface of the photoreceptor 41 based on image data of an image of an original G, read by the image reading part 30, and forms an electrostatic latent image of the image of the original G on the photoreceptor 41.

The developing part 44 causes yellow toner to adhere to the electrostatic latent image formed on the photoreceptor 41. Thereby, on the surface of the photoreceptor 41, a yellow toner image is formed. The developing part 44 of the second image forming unit 40M causes magenta toner to adhere to an electrostatic latent image formed on the photoreceptor 41 of the second image forming unit 40M, thereby forming a magenta toner image on the photoreceptor 41, the developing part 44 of the third image forming unit 40C causes cyan toner to adhere to an electrostatic latent image formed on the photoreceptor 41 of the third image forming unit 40C, thereby forming a cyan toner image on the photoreceptor 41, and the developing part 44 of the fourth image forming unit 40K causes black toner to adhere to an electrostatic latent image formed on the photoreceptor 41 of the fourth developing unit 40K, thereby forming a black toner image on the photoreceptor 41, respectively.

The yellow, magenta, cyan and black toner images formed on the photoreceptors 41 are transferred onto the intermediate transfer belt 50, respectively, which is an example of the image carrier. The cleaning parts 45 remove the toner remaining on the surfaces of the photoreceptors 41 after the toner images have been transferred, respectively, to the intermediate transfer belt 50.

The intermediate transfer belt 50 is formed in an endless shape, and is rotated in the clockwise direction opposite to the rotation direction of the photoreceptor 41 by a drive motor, not shown schematically. At the positions in the intermediate transfer belt 50, opposing to the photoreceptors of the image forming units 40Y, 40M, 40C, and 40K, respectively, primary transfer parts 51 are provided. The primary transfer parts 51 transfer the toner images formed on the photoreceptors 41 to the intermediate transfer belt 50 by applying the polarity opposite to that of the toner of the toner images, to the intermediate transfer belt 50.

Then, by rotation of the intermediate transfer belt 50, the toner images formed by the four image forming units 40Y, 40M, 40C, and 40K on respective photoreceptors 41 are transferred sequentially onto the surface of the intermediate transfer belt 50. Due to this, on the intermediate transfer belt 50, the yellow, magenta, cyan, and black toner images overlap one another, and thereby a color toner image is formed on the intermediate transfer belt 50.

In the vicinity of the intermediate transfer belt 50 and downstream of the conveyance part 23, the secondary transfer part 70 is arranged. The secondary transfer part 70 is configured by two rollers opposing to each other, and presses the sheet S conveyed thereto by the conveyance part 23, to the intermediate transfer belt 50 side by a pressure roller of the two rollers. Thereby, the color toner image formed on the intermediate transfer belt 50 is transferred onto the sheet S conveyed to the secondary transfer part 70. A cleaning part 52 removes the toner remaining on the surface of the intermediate transfer belt 50 after the color toner image has been transferred onto the sheet S. On the downstream side of the secondary transfer part 70, the fixing part 80 is provided. The fixing part 80 fixes the color toner image transferred onto the sheet S to the sheet S by applying pressure and heat.

Downstream of the fixing part 80, a switch gate 24 is arranged. The switch gate 24 switches conveyance paths of the sheet S having passed through the fixing part 80. That is, the switch gate 24 causes the sheet S to advance straight when face-up discharge in one-side image formation is performed. Thereby, the sheet S is discharged outside of the apparatus main body by a pair of discharge rollers 25. Further, the switch gate 24 guides the sheet S downward when face-down discharge in one-side image formation or both-side image formation is performed.

When face-down discharge is performed, after the sheet S has been guided downward by the switch gate 24, the surface and the undersurface of the sheet S are reversed by a sheet reversal conveyance part 26, and the sheet S is conveyed upward. Then, the sheet S is discharged outside of the apparatus main body by the pair of discharge rollers 25.

When both-side image formation is performed, after the sheet S has been guided downward by the switch gate 24, the surface and the undersurface of the sheet S are reversed by the sheet reversal conveyance part 26, and the sheet S is conveyed to the transfer position again through a re-feed path 27.

On the downstream side of the pair of discharge rollers 25, it is possible to arrange a post-processing device configured to fold the sheet S, perform stapling processing on the sheet S, etc.

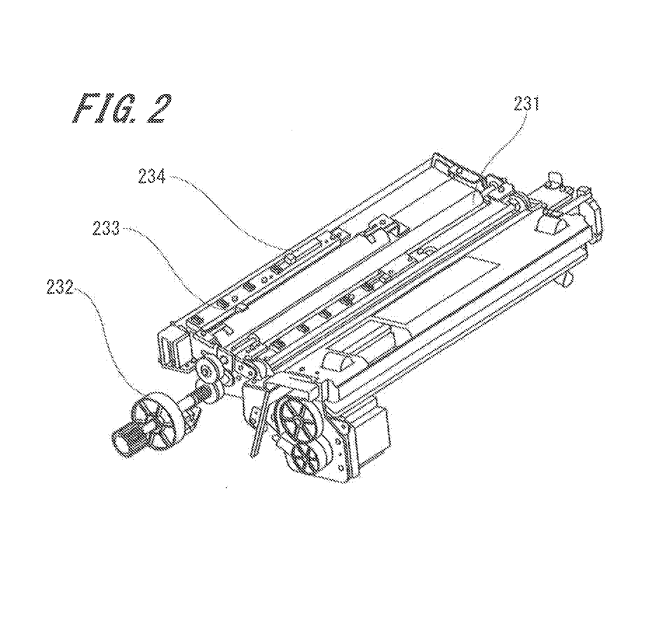

FIG. 2 shows configurations of a registration roller and its peripheral portions in the conveyance part 23 in FIG. 1. In the conveyance part 23, a registration roller 231 is arranged on the side of the secondary transfer part 70 in FIG. 1. After conveying a sheet S to the registration roller 231 by a conveyance roller, not shown schematically, the conveyance part 23 sends out the sheet S to the secondary transfer part 70 by the registration roller 231 at the timing that a toner image on the intermediate transfer belt 50 is transferred onto the sheet S.

The conveyance part 23 is provided with a transfer material main-scanning direction position correcting mechanism, such as an oscillation motor, not shown schematically, for moving the registration roller 231 in the main-scanning direction. Because of this, as a gear to transmit the rotational driving force from a motor for rotating the registration roller 213, not shown schematically, to the registration roller 231, a spur gear 232 capable of displacement in the thrust direction is used.

On the downstream side (on the top-left side in the diagram) of the registration roller 231, a deviation sensor 233 configured to detect a deviation in position in the main-scanning direction of a sheet started to be sent out from the registration roller 231 is provided. The deviation sensor 233 detects the deviation in position in the main-scanning direction of the sheet by detecting the side end of the sheet started to be sent out from the registration roller 231. Further, on the downstream side of the registration roller 231, a tip timing sensor 234 configured to detect the timing that a sheet is sent out from the registration roller 231 is provided. The tip timing sensor 234 detects the timing that the sheet is sent out from the registration roller by detecting the tip of the sheet started to be sent out from the registration roller 231.

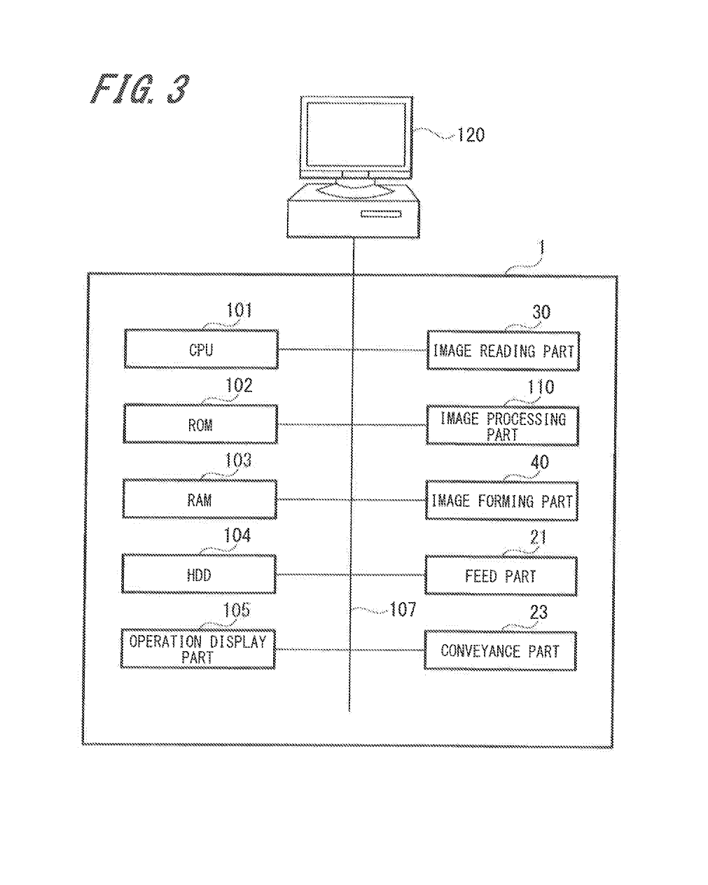

FIG. 3 shows a configuration of a control system of the image forming apparatus 1. The image forming apparatus 1 has, for example, a CPU (Central Processing Unit) 101, a ROM (Read Only Memory) 102 for storing programs etc. to be executed by the CPU 101, and a RAM (Random Access Memory) 103 used as a work area of the CPU 101. Further, the image forming apparatus 1 has a hard disk drive (HDD) 104 as a large-capacity storage device, and an operation display part 105. As the ROM 102, normally, an electrically erasable programmable ROM is used.

The CPU 101 is an example of a control part of the present invention. The CPU 101 is connected to the ROM 102, the RAM 103, the HDD 104, and the operation display part 105, respectively, via a system bus 107, and controls the whole of the apparatus. Further, the CPU 101 is connected to the image reading part 30, an image processing part 110 described later, the image forming part 40, the feed part 21, and the conveyance part 23, via the system bus 107.

The HDD 104 stores image data of an image of an original obtained by reading the image of the original by the image reading part 30, and stores image data already output, etc., as well. The operation display part 105 is a touch panel configured by a display, such as a liquid crystal display (LCD), an organic ELD (Electro Luminescence Display), etc. The operation display part 105 displays a menu of instructions to a user, information on acquired image data, etc. The operation display part 105 further includes a plurality of keys, and receives input of data, such as various kinds of instructions, characters, and numerals, etc., by the key operation of a user, and outputs input signals.

The image reading part 30 optically reads an image of an original, and generates image data thereof. For example, when reading an image of a color original, the image reading part 30 generates image data having 10-bit luminance information for each of RGB per pixel. The image data generated by the image reading part 30, and image data transmitted from a PC (personal computer) 120, which is en example of the external device connected to the image forming apparatus 1, are sent to the image processing part 110, and subjected to image processing. The image processing part 110 performs processing on the received image data, such as analog processing, A/D conversion, shading correction, image compression, etc.

In the present embodiment, the example is explained in which a personal computer is used as the external device, but the embodiment is not limited to this example, and it is possible to use other various kinds of devices, for example, a facsimile machine, etc., as the external device.

When a color image is formed, for example, by the image forming apparatus 1, image data of R, G, and B, generated by the image reading part 30, etc., is input to a color conversion LUT (look up table) in the image processing part 110. Then, the image processing part 110 performs color conversion of the R, C, and B data into image data of Y, M, C, and Bk. On the image data having been subjected to color conversion, correction of tone reproduction characteristics, screen processing of halftone dots, etc. by referring to a density correction LUT (look up table), edge processing to highlight a fine line, etc., are performed.

The image forming part 40 receives image data having been subjected to image processing by the image processing part 110, and forms toner images of respective colors of Y, M, C and Bk on the photoreceptors 41, based on the received image data.

From the conveyance part 23, signals indicating detection results by the deviation sensor 233 and the tip timing sensor 234 shown in FIG. 2 are transmitted to the CPU 101. The CPU 101 controls the conveyance part 23 based on the detection results of the sensors 233 and 234 to perform correction of the sheet position in the main-scanning direction and correction of the sheet position in the sub-scanning direction.

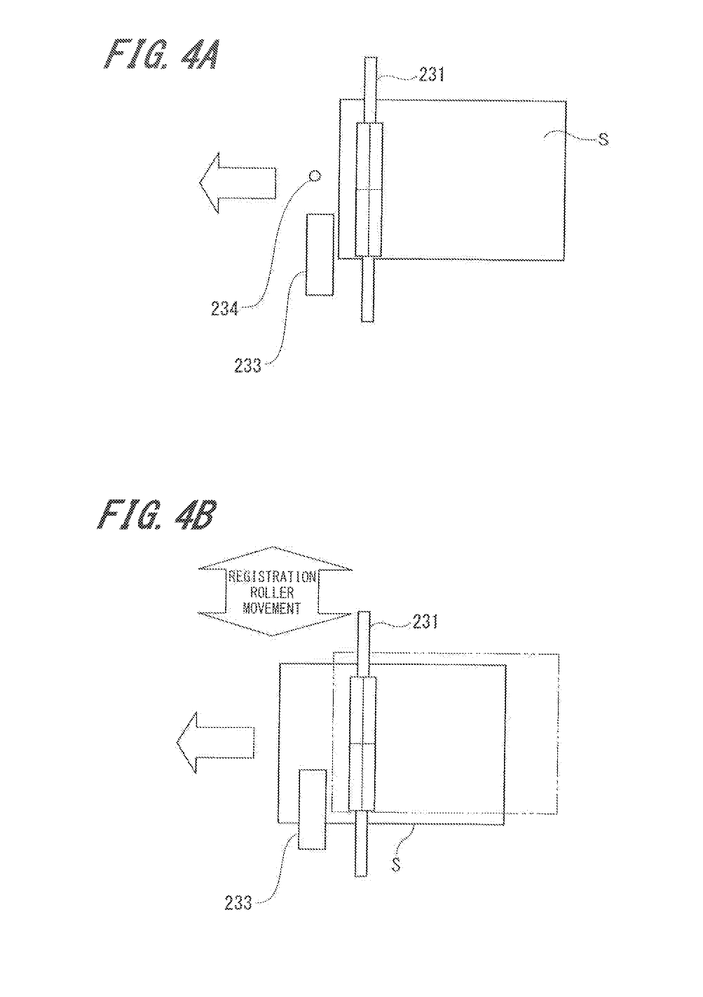

FIG. 4A and FIG. 4B show contents of the correction of the sheet position in the main-scanning direction by the transfer material main-scanning direction position correction mechanism, performed by the CPU 101. As shown in FIG. 4A, when a sheet S is started to be sent out in the leftward direction in FIG. 4A from the registration roller 231 by the CPU 101 causing the registration roller 231 to start rotation by the motor for rotating the registration roller 231, not shown schematically, the deviation sensor 233 detects a deviation in position of the sheet S in the main-scanning direction perpendicular to the conveyance direction of the sheet S (in the longitudinal direction in FIG. 4A). As shown in FIG. 4B, in accordance with the detection result, the CPU 101 causes the oscillation motor, not shown schematically, to move the registration roller 231 in the main-scanning direction to correct the position of the sheet S in the main-scanning direction when the sheet S is sent out by the registration roller 231 from the conveyance part 23 toward the secondary transfer part 70.

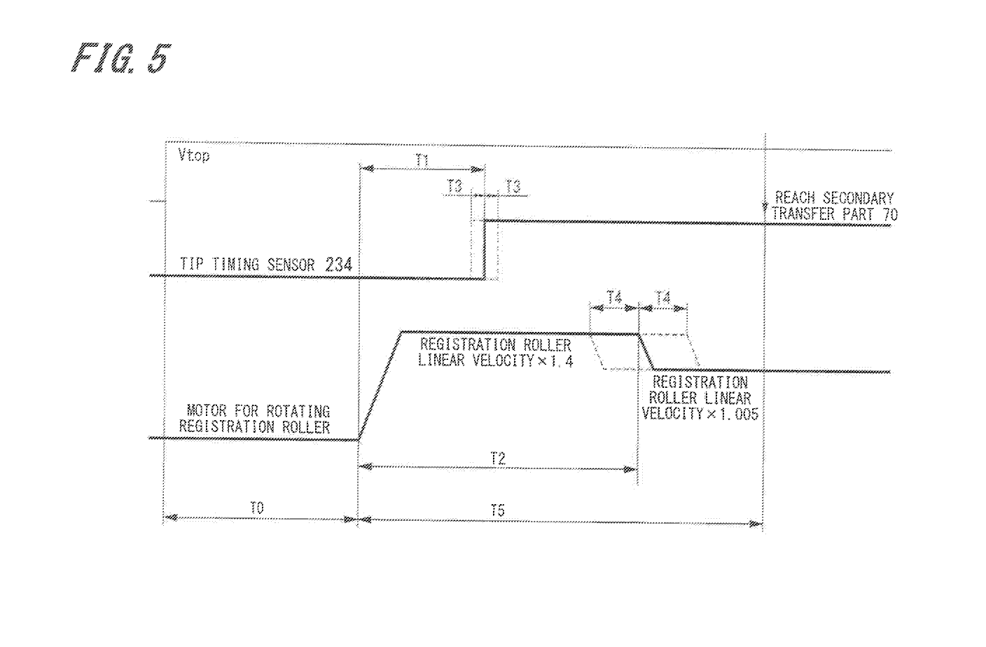

FIG. 5 shows contents of the correction of the sheet position in the sub-scanning direction performed by the CPU 101, and time is represented in the transverse direction. From the image forming part 40 shown in FIG. 1, at a predetermined timing in the process of forming toner images on the photoconductors 41, an image synchronization signal Vtop is transmitted to the CPU 101. If the CPU 101 receives the image synchronization signal Vtop, in accordance with required time T0+T5 necessary for the color toner image on the intermediate transfer belt 50 to reach the secondary transfer part 70 in FIG. 1, after time T0 has elapsed, the CPU 101 causes the registration roller 231 to start rotation by the motor for rotating the registration roller 231 at a velocity 1.4 times the constant linear velocity (the same linear velocity as that of the intermediate transfer belt 50 in FIG. 1) to send out the sheet S from the conveyance part 23 to the secondary transfer part 70.

In the case where the sheet S is sent out normally, the tip of the sheet S is detected by the tip timing sensor 234 in FIG. 2 when time T1 has elapsed after the start of rotation of the registration roller 231. However, in actuality, there is a case where the sheet S is not sent out normally and variations of ±T3 occur in the time before the tip of the sheet S is detected. For example, if the start of sending out of the sheet S is delayed because the sheet S slips at the time of the start of rotation of the registration roller 231, the time before the tip of the sheet S is detected becomes longer.

In the case where the time before the tip of the sheet S is detected is T1, the CPU 101 reduces the rotational velocity of the registration roller 231 to a velocity about 1.005 times the constant linear velocity when time T2 has elapsed after the start of rotation of the registration roller 231, and thereby the sheet S is caused to reach the secondary transfer part 70 when time T5 has elapsed after the start of rotation of the registration roller 231 (that is, in the timing that the color toner image on the intermediate transfer belt 50 reaches the secondary transfer part 70).

On the other hand, in the case where variations of ±T3 occur in the time before the tip of the sheet S is detected, the CPU 101 increases or decreases the time before the rotational velocity of the registration roller 231 is reduced to the velocity 1.005 times the constant linear velocity by ±T4, and thereby the sheet S is caused to reach the secondary transfer part 70 when time T5 has elapsed after the start of rotation of the registration roller 231. For example, in the case where the start of sending out of the sheet S is delayed and the time before the tip of the sheet S is detected is lengthened, the CPU 101 makes the time before the rotational velocity of the registration roller 231 is reduced to the velocity 1.005 times the constant linear velocity longer than T2 so that the time for sending out the sheet S at the velocity 1.4 times the constant linear velocity is made longer to make up for the delay, and thus, the sheet S is caused to reach the secondary transfer part 70 when time T5 has elapsed after the start of rotation of the registration roller 231.

As described above, by increasing or decreasing the time before the rotational velocity of the registration roller 231 is reduced, the correction of variations in the timing that the sheet is sent out from the registration roller 231, that is, the correction of the sheet position in the sub-scanning direction when the color toner image on the intermediate transfer belt 50 is transferred at the transfer part 70 onto the sheet S conveyed thereto, is performed.

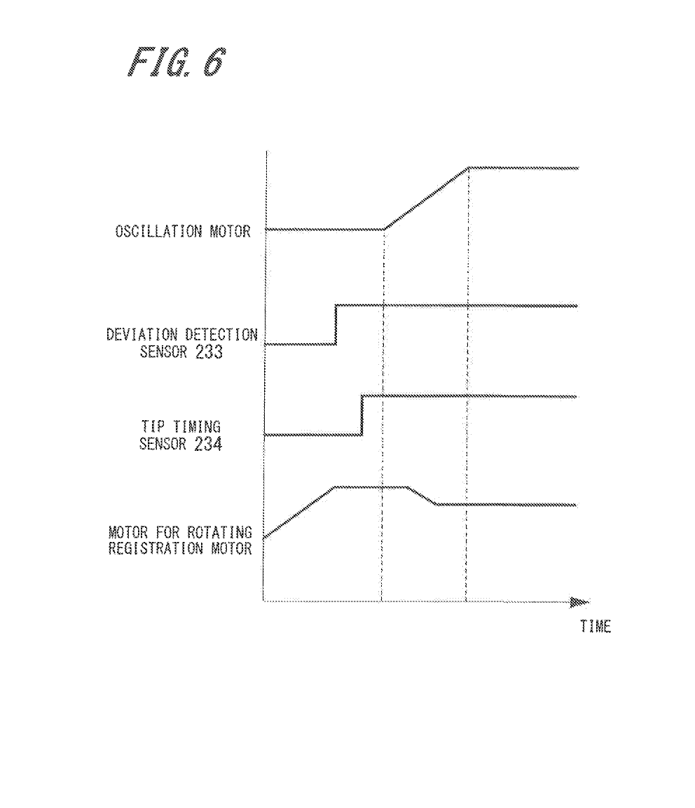

FIG. 6 shows a temporal relationship between the correction of the sheet position in the main-scanning direction shown in FIG. 4 and the correction of the sheet position in the sub-scanning direction shown in FIG. 5, and time is represented in the transverse direction. The CPU 101 causes the registration roller 231 to move in the main-scanning direction by the oscillation motor in accordance with the detection result of the deviation sensor 233 as explained above using FIG. 4A and FIG. 4B, after causing the registration roller 231 to start rotation at the velocity 1.4 times the constant linear velocity by the motor for rotating the registration motor 231 as explained above using FIG. 5.

Further, when the tip of the sheet S is detected by the tip timing sensor 234, the CPU 101 reduces the rotational velocity of the registration roller 231 to the velocity 1.005 times the constant linear velocity as shown in FIG. 5 while moving the registration roller 231 in the main-scanning direction by the oscillation motor.

In this manner, after causing the registration roller 231 to start rotation in order to send out the sheet S from the registration roller 231 to the secondary transfer part 70, the CPU 101 performs the correction of the sheet position in the main-scanning direction by causing the registration roller 231 to move in the main-scanning direction and the correction of the sheet position in the sub-scanning direction by reducing the rotational velocity of the registration roller 231, in a time overlapping manner, as shown in a period of time indicated by two dot lines in FIG. 6.

As described above, according to the image forming apparatus of the embodiment, the correction of the sheet position in the main-scanning direction by the transfer material main-scanning direction position correction mechanism and the correction of the sheet position in the sub-scanning direction by changing the rotational velocity of a roller to which the rotational driving force is transmitted by a spur gear are performed in a time overlapping manner. Consequently, it is possible to secure the time for performing the correction of the sheet position in the sub-scanning direction that is longer than in the case where the correction of the sheet position in the sub-scanning direction is started after the correction of the sheet position in the main-scanning direction has been completed, that is, it is possible to reduce the rotational velocity of the registration roller 231 by spending a longer time. Due to this, when reducing the rotational velocity of the registration roller 231 to the velocity 1.005 times the constant linear velocity in order to perform the correction of the sheet position in the sub-scanning direction, it is possible to reduce the amount of change in the rotational velocity of the registration roller 231 per unit time, and therefore, it is possible to prevent the rotation accuracy of the registration roller 231 from reducing even if the spur gear 232 is used as in FIG. 2 as the gear to transmit the rotational driving force to the registration roller 231.

The embodiment of the present invention has been explained above. However, the present invention is not limited to the above-mentioned embodiment, and there can be various kinds of modifications within the scope not deviating from the gist of the invention described in claims.

For example, in the above-mentioned embodiment, the example has been explained in which a color image is formed by providing the four image forming units 40Y, 40M, 40C, and 40K in the image forming part 40, but it is also possible to apply the present invention to an image forming apparatus that forms a monochrome image by providing only one image forming unit.

Further, the example has been explained in which the intermediate transfer belt 50 is provided as the image carrier onto which toner images formed on the photoreceptors 41 are sequentially transferred so as to be overlapped one upon another to form a color toner image thereupon, and the color toner image formed on the intermediate transfer belt 50 is secondarily transferred onto the sheet S from the intermediate transfer belt 50, but it is also possible to apply the present invention to an image forming apparatus that transfers a toner image formed on a photoreceptor directly from the photoreceptor to a sheet.

In the above-mentioned embodiment, the example is explained in which the sheet position in the main-scanning direction is corrected by moving the registration roller 231 in the main-scanning direction and the sheet position in the sub-scanning direction is corrected by reducing the rotational velocity of the registration roller 231. However, the present invention is not limited to this embodiment, and it is possible to apply the present invention to an image forming apparatus in which a mechanism other than the mechanism for moving the registration roller 231 in the main scanning direction is provided as the transfer material main-scanning direction position correction mechanism for correcting the sheet position in the main-scanning direction. It is also possible to apply the present invention to an image forming apparatus that corrects the sheet position in the sub-scanning direction by changing the rotational velocity of a roller other than the registration roller 231, to which the rotational driving force is transmitted by a spur gear.

What is claimed is:

1. An image forming apparatus comprising
an image carrier onto which toner images formed by an image forming part are sequentially transferred so as to overlap one another and form a toner image thereupon;
a transfer part configured to transfer the toner image formed on the image carrier onto a transfer material conveyed thereto;
a conveyance part configured to send out the transfer material, onto which the toner image on the image carrier is to be transferred at the transfer part, toward the transfer part, the conveyance part including a roller to which a rotational driving force is transmitted and which, by being rotated by the rotational driving force, sends out the transfer material toward the transfer part, and a transfer material main-scanning direction position correction mechanism configured to correct a position of the transfer material in a main-scanning direction when the transfer material is sent out by the roller from the conveyance part toward the transfer part; and
a control part configured to perform the correction of the position of the transfer material in the main-scanning direction by the transfer material main-scanning direction position correction mechanism of the conveyance part, and correction of a position of the transfer material in a sub-scanning direction when the toner image on the image carrier is transferred at the transfer part onto the transfer material conveyed thereto by changing a rotational velocity of the roller of the conveyance part, in a time overlapping manner.

2. The image forming apparatus according to claim 1, wherein the transfer material main-scanning direction position correction mechanism of the conveyance part corrects the position of the transfer material in the main-scanning direction when the transfer material is sent out from the conveyance part, by moving the roller of the conveyance part in the main-scanning direction.

3. The image forming apparatus according to claim 2, wherein the control part performs the correction of the position of the transfer material position in the main-scanning direction by moving the roller of the conveyance part in the main-scanning direction by the transfer material main-scanning direction position correction mechanism of the conveyance part, and the correction of the position of the transfer material in the sub-scanning direction by changing the rotational velocity of the roller of the conveyance part, in a time overlapping manner, after causing the roller to start rotation in order to send out the transfer material toward the transfer part.

4. The image forming apparatus according to claim 1, wherein the conveyance part includes a transmission gear configured to transmit the rotational driving force to the roller, and the transmission gear is a spur gear capable of displacement in a thrust direction.
